(19) United States
(12) Patent Application Publication
(10) Pub. No.: US 2012/0137580 A1
(43) Pub. Date: Jun. 7, 2012

(54) SYSTEM, WATERING DEVICE AND METHOD FOR DEVELOPING ROOTS ON PLANT CUTTINGS

(75) Inventor: Cornelis Wilhelmus Dekker, RK Henbroek (NL)

(73) Assignee: DEKKER CHRYSANTEN B.V., RP Hensbroek (NL)

(21) Appl. No.: 13/382,663

(22) PCT Filed: Jul. 7, 2010
(86) PCT No.: PCT/NL2010/050435

§ 371 Date: Feb. 10, 2012

(30) Foreign Application Priority Data
Jul. 9, 2009 (NL) NL2003165

(51) Int. Cl. A47G 9/10; A01G 9/02

(52) U.S. Cl. 47/65.9; 47/66.7; 137/574

(57) ABSTRACT

A system for treating plant cuttings (12), comprising a carrier (1) and a series of holders attached to said carrier, which holders are each designed for holding a plant cutting, said holders being attached to the carrier in such a manner that plant cuttings inserted into the holders extend substantially parallel to each other, and that the respective centres of each of the holders lie substantially in one and the same central plane, which system further comprises a watering device comprising at least one gutter (22) in which the bottom sides of the plant cuttings can be placed, which gutter extends between a water supply side and a water discharge side, as well as a water inlet designed to supply water or on the water supply side and a water outlet designed to discharge water from the water discharge side.

The present invention relates to a system for treating plant cuttings, comprising a carrier and a series of holders attached to said carrier, which holders are each designed for holding a plant cutting, said holders being attached to the carrier in such a manner that plant cuttings inserted into the holders extend substantially parallel to each other, and that the respective centres of each of the holders lie substantially in one and the same central plane. Such a system is described in WO 00/52996. Said system makes it possible to transport plant cuttings on a relatively small surface area and to subject them to an initial treatment, for example in a climate chamber.

Cutting is a method of vegetative reproduction of plants for the purpose of obtaining genetically identical culture material.

Plant parts are cut from existing plants and, after being subjected to a treatment, cultivated to fully-grown plants. The severed plant cuttings must be subjected to a precise temperature and humidity treatment so as to acquire sufficient roots to grow into fully fledged plants.

In the prior art the severed plant cuttings are placed in culture material, for instance soil, sand or substrate, after which the thus prepared plant cuttings are subjected to a temperature and humidity treatment.

This procedure has the drawback that the plant cuttings placed in culture material take up much space.

Another problem lies in transport of the plant cuttings; plant cuttings are usually taken in countries with a warm climate, after which they are transported to countries with a temperate climate where the plants are cultivated. Accordingly there is a need for holders for the plant cuttings in which the plant cuttings can be easily transported while taking up the least amount of space, for instance as air freight, and subsequently be cultivated into plants in as short a time as possible, using as few operations as possible and taking up as little space as possible.

These drawbacks are in part obviated by the system described in WO 00/52996. An advantage of the carrier described therein is that it enables mechanical processing, for instance striking, of the plant cuttings. The supply of the plant cuttings in individualized form and with defined position is of paramount importance in this connection; these measures first make it possible for a machine to take hold of the cuttings one by one and—after possible treatment—place them in a culture pot. Generally a culture pot is to that end provided with a hole. This application is particularly important in the case of chrysanthemums.

The object of the invention is to realise a further improvement of the system. The invention in particular aims at realising a further cost saving in the cultivation of plants, in particular chrysanthemums.

In order to accomplish that object, the system further comprises a watering device comprising at least one gutter in which the bottom sides of the plant cuttings can be placed, which gutter extends between a water supply side and a water discharge side, as well as a water inlet designed to supply water or on the water supply side and a water outlet designed to discharge water from the water discharge side. Tests have shown that the end result can be achieved within a shorter period of time and at lower cost if the plant cuttings—prior to being placed in earth—are first supplied with water until there is a beginning of root formation. Such a beginning of root formation is characterised by a small, just discernible thickening at the bottom side of the plant cutting. Another advantage of the invention is that the plant cuttings, on account of their stay in the watering device, can remain on a relatively small surface area for a longer period of time.

Preferably, a water outlet is provided on the water discharge side of the watering device, and a water inlet is preferably provided on the water supply side of the watering device.

A water threshold is disposed between the water supply side and the water discharge side of the watering device, preferably near the water discharge side, and preferably also near the water supply side, which water threshold determines the water level in the gutter in use.

The gutter preferably has a width such that the bottom side of the carrier with the bottom sides of the plant cuttings present therein can be placed therein. The gutter preferably has a narrowed portion near the bottom, the width of said narrow portion being such that the carrier does not fit therein, so that water can flow under the carrier.

The watering device preferably comprises a multitude of parallel gutters, the distance between the central axes of the gutters preferably being less than 5 cm, more preferably less than 3 cm. The spacing between the holders on a carrier is preferably also less than 5 cm, more preferably less than 3 cm. In this way a large number of plant cuttings can be placed on a relatively small surface area for starting the root formation.

The water threshold is preferably located some distance from the ends of the gutters, such that water can flow freely between said gutter ends. This helps to realise a uniform water level in all the gutters.

At least that part of the watering device which comprises the gutters is made of a bent plate in the preferred embodiment.

The invention also relates to a watering device as described above.

The invention further relates to a method for treating plant cuttings, comprising:
the connecting of unrooted plant cuttings to a carrier, such that the plant cuttings extend substantially parallel to each other, substantially in one and the same central plane, wherein the bottom sides of the plant cuttings are placed in at least one gutter of a watering device, which gutter extends between a water supply side and a water discharge side, wherein water is supplied on the water supply side and water is discharged from the water discharge side, such that the water in the gutter moistens the bottom sides of the plant cuttings. The carrier with the plant cuttings is preferably removed from the gutter shortly after root formation on the plant cuttings can be discerned and the plant cuttings are subsequently removed from the carrier and placed in earth. Preferably, a carrier with the plant cuttings is placed in a gutter parallel to another carrier, maintaining a spacing between the plant cuttings in the various carriers of less than 5 cm, preferably less than 3 cm.

The present invention will now be explained in more detail with reference to the accompanying figures, in which:

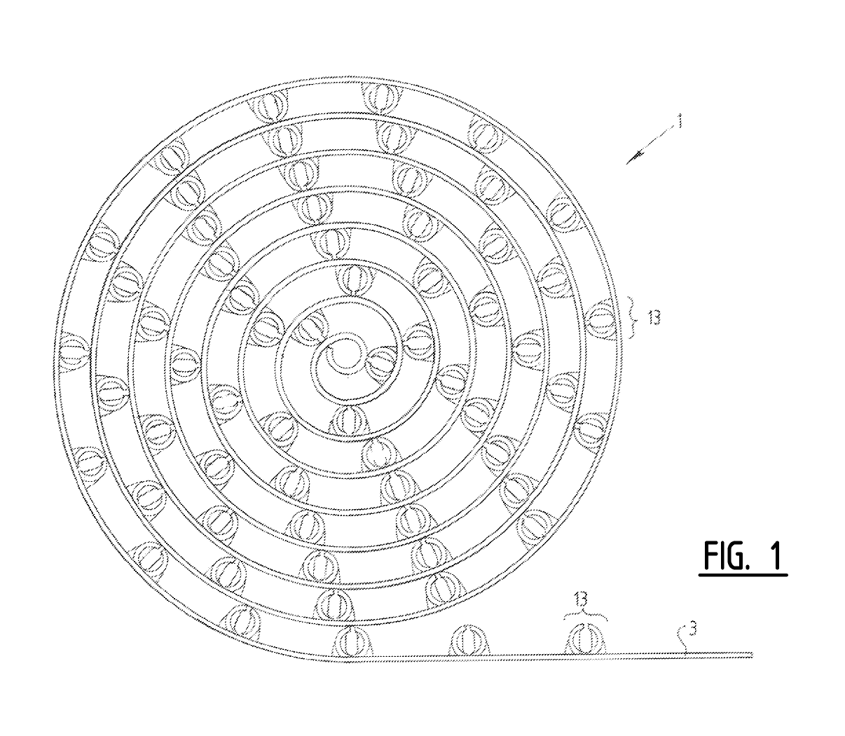

FIG. 1 is a top plan view of a carrier in rolled-up condition, which is shown to comprise a series of clamping elements attached to the carrier;

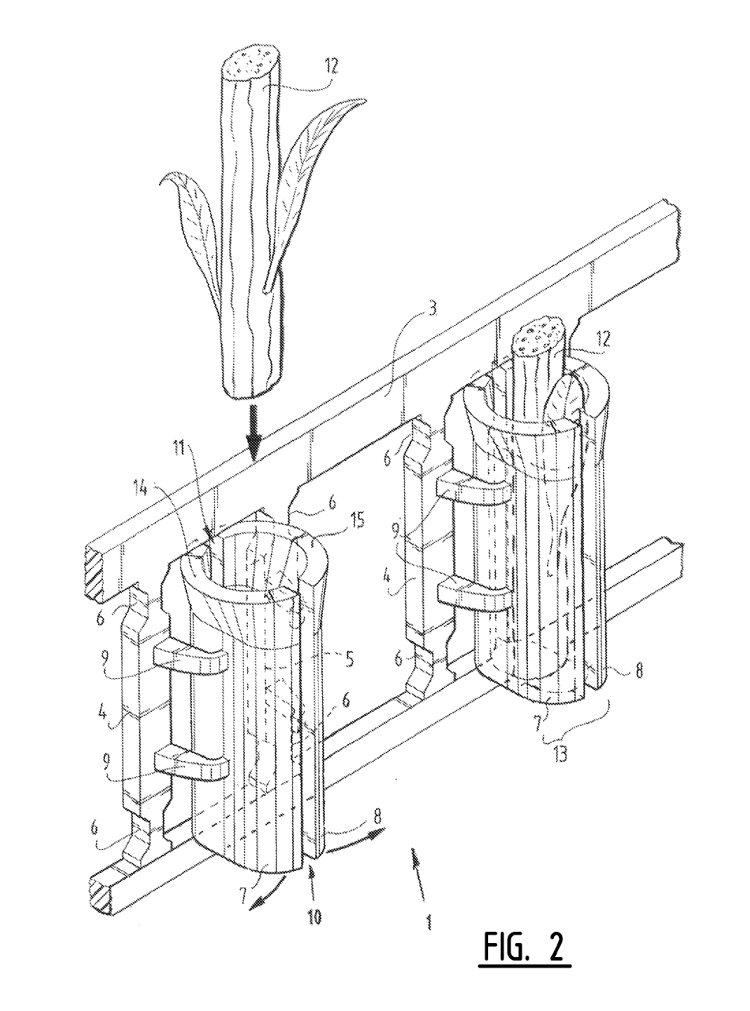

FIG. 2 shows part of a carrier in unrolled condition, showing two clamping elements attached to the carrier, in which plant cuttings are placed;

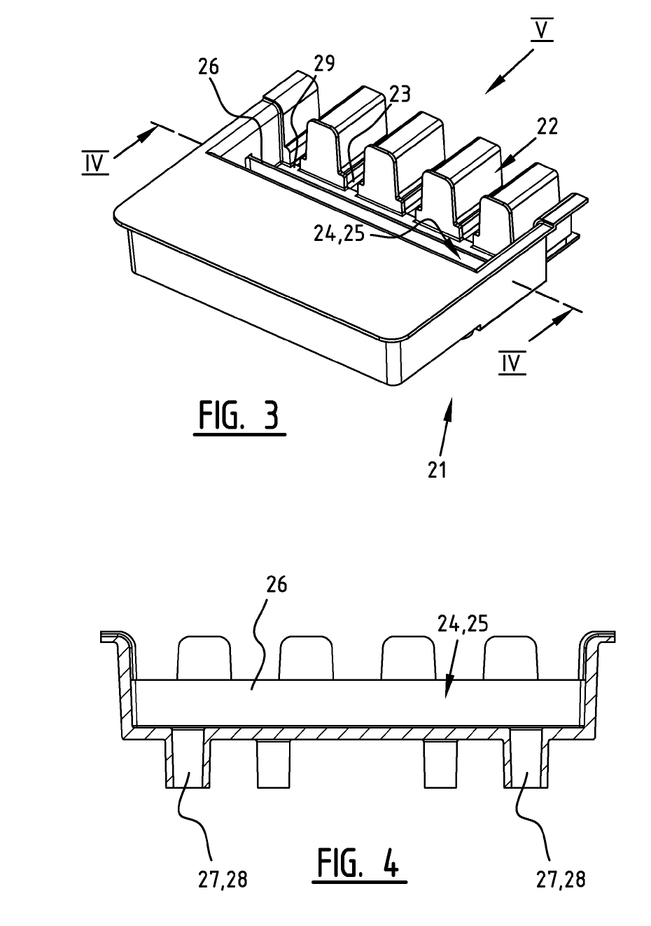

FIG. 3 is a perspective view showing the end of watering device;

FIG. 4 is a sectional view according to the arrows IV of the end of the watering device;

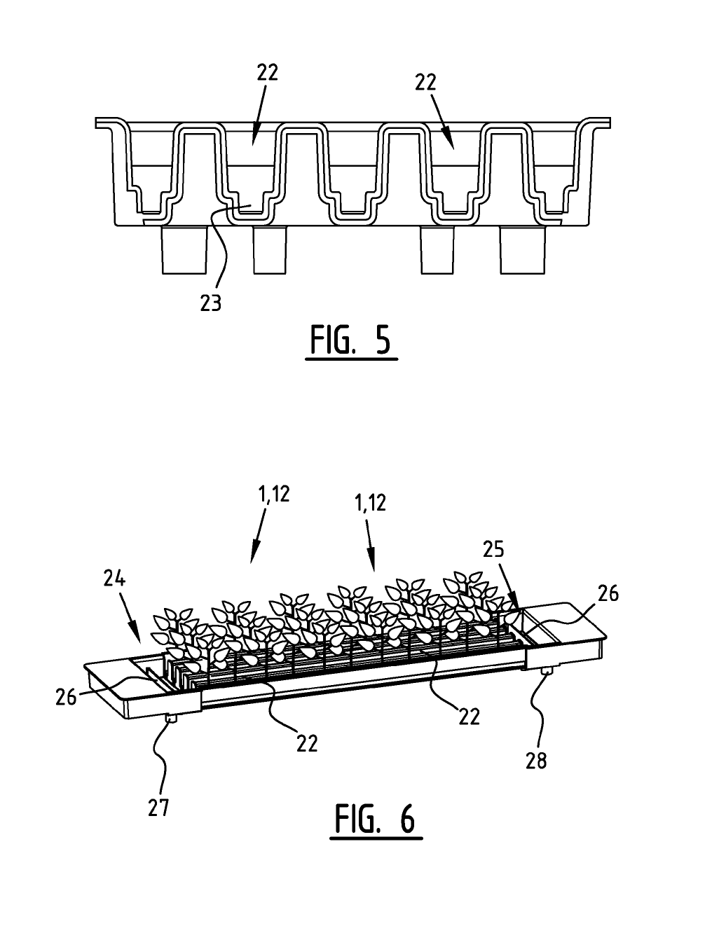

FIG. 5 is a sectional view according to the arrow V of the end of the watering device; and

FIG. 6 shows a watering device in which the carriers with plant cuttings are placed.

FIG. 1 shows a part of a rolled-up carrier 1, which is formed by a lower strip of material 2 and an upper strip of material 3 extending parallel thereto, and holders for plant cuttings in the form of clamping elements 13, which are attached thereto at regular intervals of about 29 mm. In the embodiment shown in FIG. 1, the selection of the material is such that the strips 2, 3 of FIG. 1 are flexible to a certain extent, making it possible to roll them up. In an alternative embodiment, the carriers 1 may also have a rigid linear shape.

As FIG. 2 shows, the two strips 2, 3 are interconnected at the location of a clamping element 13 by two elements 4, 5, respectively, extending perpendicularly to the longitudinal direction of the steps of material 2, 3. The two elements 4, 5 have a narrowed portion 6 near the location where they are attached to the two strips 2, 3.

The clamping elements are made up of two substantially semi-cylindrical elements 7, which are each attached to the bridge elements 4, 5, respectively, by means of two bridges 8. The two semi-cylindrical elements 7, 8 are separated on both sides by gap 10 and 11, respectively. On account of the presence of the narrowed portions 6 of the bridge elements 4, 5, respectively, a force towards each other of the semicylindrical elements 7, 8 is set up when said semi cylindrical elements are moved apart. This is also a question of dimensioning, however, and said force also depends on the selected type of material, in particular the properties of the plastic material in question.

Inserting the plant cuttings 12 is facilitated by the presence of an upwardly converging part 14, 15, respectively, provided at the upper side of each of the semi-cylindrical elements 7, 8. As a result, a kind of funnel is formed. The strip 2 extends under the space between the semi-cylindrical elements 7, 8 to a certain extent, thus preventing plant cuttings 12 from falling through the bottom side.

The inner side of the semi-cylindrical elements 7, 8 may have a fairly random shape; it may have the shape of a circular cylinder, but it may also be slightly oval.

Other embodiments of carriers for plant cuttings suitable for use in the present invention are described in International patent publication WO 00/52996.

FIGS. 3, 4 and 5 show the end of a watering device, which comprises a substantially plate-shaped element comprising five parallel gutters 22, in which the carriers 1 with the plant cuttings 12 shown in FIG. 2 can be placed, as is shown in FIG. 6. The width of a gutter 22 is about 13 mm and approximately the same, but just a little larger than the width of the carriers with the holders. Present at the bottom of said upper, wider part of the gutters 22 is a narrowed portion 23, which is narrower than the width of the carriers 1 with the holders 13, viz. approximately 7 mm. As a result, water can flow freely through the gutters 22 under the carriers 1 with the plant cuttings 12. The height of the wide portion of the gutter is approximately 18 mm, and the height of the narrower portion 23 is 6 mm. The distance between the central axes of the gutters is 29 mm.

The gutters 22 may have a length of 1 m, for example, but a much greater length is also possible, for example 20 m. Present at the two ends of the gutters 22 is a water supply tank 24 and a water discharge tank 25, which are separated from the gutters 22 by water thresholds 26. Present in the water supply tank 24 are inlets 27, which can be connected to a water supply pipe, whilst water outlets 28 are present in the water discharge tank, which water outlets can be connected to a discharge pipe.

The water thresholds 26 are spaced from the ends of the gutters, so that the water can flow freely in the space between the ends. In this way a uniform water level in all the gutters is ensured, which water level is the same as the height of the water thresholds 26.

1. A system for treating plant cuttings, comprising a carrier and a series of holders attached to said carrier, the holders are each designed for holding a plant cutting, said holders being attached to the carrier in such a manner that plant cuttings inserted into the holders extend substantially parallel to each other, and that respective centres of each of the holders lie substantially in one and the same central plane, and a watering device comprising at least one gutter in which bottom sides of the plant cuttings can be placed, the at least one gutter extends between a water supply side and a water discharge side, a water inlet is designed to supply water on the water supply side and a water outlet is designed to discharge water from the water discharge side.

2. A system according to claim 1, wherein the water outlet is provided on the water discharge side of the watering device.

3. A system according to claim 1 wherein the water inlet is provided on the water supply side of the watering device.

4. A system according to claim 1, wherein a water threshold is disposed between the water supply side and the water discharge side of the watering device, wherein the water threshold determines the water level in the gutter in use.

5. A system according to claim 1, wherein the gutter has a width such that a bottom side of the carrier with the bottom sides of the plant cuttings present therein can be placed therein.

6. A system according to claim 1, wherein the gutter has a narrowed portion near a bottom, the width of said narrowed portion being such that the carrier does not fit therein.

7. A system according to claim 4, wherein the watering device comprises a multitude of parallel gutters.

8. A system according to claim 7, wherein the distance between central axes of the multitude of parallel gutters is less than 5 cm.

9. A system according to claim 1, wherein the spacing between the holders on a carrier is less than 5 cm.

10. A system according to claim 7, wherein the water threshold is located some distance from ends of the multitude of parallel gutters, such that water can flow freely between said gutter ends.

11. A system according to claim 1, wherein at least a part of the watering device which comprises the at least one gutter is made of a bent plate.

12. A system according to claim 1, wherein said holders each are formed by two substantially semi-cylindrical elements.

13. A system according to claim 1, wherein each carrier comprises exactly one row of holders.

14. A watering device comprising at least one gutter in which bottom sides of the plant cuttings can be placed, the gutter extends between a water supply side and a water discharge side, a water inlet is designed to supply water on the water supply side and a water outlet is designed to discharge water from the water discharge side.

15. A method for treating plant cuttings, comprising the connecting of unrooted plant cuttings to a carrier, such that the plant cuttings extend substantially parallel to each other, substantially in one and the same central plane, wherein bottom sides of the plant cuttings are placed in at least one gutter of a watering device, which gutter extends between a water supply side and a water discharge side, wherein water is supplied on the water supply side and water is discharged from the water discharge side, such that the water in the gutter moistens the bottom sides of the plant cuttings.

16. A method according to claim 15, wherein the carrier with the plant cuttings is removed from the gutter shortly after root formation on the plant cuttings can be discerned and the plant cuttings are subsequently removed from the carrier and placed in earth.

17. A method according to claim 15, wherein a carrier with the plant cuttings is placed in a gutter parallel to another carrier, maintaining a spacing between the plant cuttings in the various carriers of less than 5 cm.
